(19) United States
(12) Patent Application Publication
(10) Pub. No.: US 2026/0166592 A1
(43) Pub. Date: Jun. 18, 2026

(54) FLUID FLOW CONTROL APPARATUS

(71) Applicants: HYUNDAI MOTOR COMPANY, Seoul (KR); KIA CORPORATION, Seoul (KR)

(72) Inventors: Hae Jun Jeong, Hwaseong-si (KR); Yoon Geun Cho, Hwaseong-si (KR); Ki Tae Kim, Hwaseong-si (KR)

(73) Assignees: HYUNDAI MOTOR COMPANY, Seoul (KR); KIA CORPORATION, Seoul (KR)

(21) Appl. No.: 19/253,259

(22) Filed: Jun. 27, 2025

(30) Foreign Application Priority Data
Dec. 13, 2024 (KR) 10-2024-0185357

(51) Int. Cl. B08B 3/02; G05D 7/06

(52) U.S. Cl. CPC B08B 3/02; G05D 7/0652

(57) ABSTRACT

A fluid flow control apparatus includes a cooling function. The fluid flow control apparatus includes at least one controllable first valve configured to selectively discharge a first fluid through at least one first outlet, and a first flow path disposed to allow the first fluid to flow therethrough and surround the at least one first valve.

### CROSS-REFERENCE TO RELATED APPLICATION

This application claims under 35 U.S.C. § 119(a) the benefit of priority from Korean Patent Application No. 10-2024-0185357, filed on Dec. 13, 2024, the entire contents of which are incorporated herein by reference.

### BACKGROUND

### Technical Field

The present disclosure relates to an apparatus for controlling fluid flow. More particularly, it relates to a fluid flow control apparatus including a cooling function.

### Background Art

A solenoid valve is an electromechanically operated valve that may be used to control the flow of fluid through a flow path. The solenoid valve may include a coil to which current is applied and may allow or block the fluid flow through the flow path by applying or not applying the current.

When power is supplied to the solenoid valve, heat is generated due to the current flowing through the coil. If the solenoid valve is excessively heated, normal operation of the solenoid valve cannot be expected. Accordingly, the solenoid valve is controlled by setting the operating cycle, operating temperature, or allowable current limit of the solenoid valve.

The above information disclosed in this Background section is only to enhance understanding of the background of the disclosure. Therefore, the Background section may contain information that does not form the prior art that is already known one having ordinary skill in the art.

### SUMMARY OF THE DISCLOSURE

The present disclosure has been made in an effort to solve the above-described problems associated with the prior art, and it is an object of the present disclosure to provide a fluid flow control apparatus capable of resolving the heat generation problem of a solenoid valve.

It is another object of the present disclosure to provide a fluid flow control apparatus including a cooling function.

It is yet another object of the present disclosure to provide a fluid flow control apparatus capable of increasing the number of times a valve is operated through a cooling function.

It is further yet another object of the present disclosure to provide a fluid flow control apparatus including a cooling function without adding a complicated structure or part.

The objects of the present disclosure are not limited to the above-mentioned objects, and other objects not mentioned herein should be clearly understood by persons of ordinary skill in the art to which the present disclosure pertains (referred to as “those having ordinary skill in the art”) from the following description.

In order to achieve the above-described objects of the present disclosure and perform the characteristic functions of the present disclosure, which are described below, the features of the present disclosure are as follows.

In one aspect, the present disclosure provides a fluid flow control apparatus including one or more first controllable valves configured to selectively discharge a flow of a first fluid through one or more first outlets and a first flow path allowing the flow of the first fluid to flow through the first flow path and disposed to surround the one or more first controllable valves.

In another aspect, a method of controlling a fluid flow control apparatus may include measuring a current temperature and a current pressure of a fluid flowing through a flow path of the fluid flow control apparatus. The flow path may include one or more outlets configured to discharge the fluid. An openable valve may be disposed at each of the one or more outlets. The flow path may be disposed to surround the valves. The method may further include determining whether to open a valve based on the current temperature and the current pressure of the fluid.

In still another aspect, a sensor cleaning system includes one or more first nozzles and a fluid flow control apparatus configured to direct a first fluid to each of the one or more first nozzles. The fluid flow control apparatus may include a first flow path configured such that the first fluid flows through the first flow path, one or more outlets connected to the first flow path and configured to be in fluid communication with each of the one or more first nozzles, and one or more first valves configured to selectively discharge the first fluid through the one or more first outlets. The first flow path may be configured to surround the one or more first valves.

Other aspects and embodiments of the disclosure are discussed below.

The above and other features of the disclosure are also discussed below.

### BRIEF DESCRIPTION OF THE DRAWINGS

The above and other features of the present disclosure are described in detail below with reference to certain embodiments thereof illustrated in the accompanying drawings which are given hereinbelow by way of illustration only, and thus are not limitative of the present disclosure, and wherein:

FIG. 1 is a block diagram of a sensor cleaning system including a fluid flow control apparatus according to one embodiment of the present disclosure;

FIG. 2 is a side view of a vehicle;

FIGS. 3 and 4 illustrate the fluid flow control apparatus according to an embodiment of the present disclosure;

FIG. 5 is a cross-sectional view of a solenoid valve of the fluid flow control apparatus according to an embodiment of the present disclosure;

FIGS. 6 and 7 illustrate the fluid flow control apparatus according to an embodiment of the present disclosure;

FIG. 8 is a graph representing the boiling points of air and ethanol according to pressure;

FIG. 9 is a flowchart representing control of the fluid flow control apparatus according to an embodiment of the present disclosure; and

FIG. 10 is a flowchart representing control of the fluid flow control apparatus according to some embodiments of the present disclosure.

It should be understood that the appended drawings are not necessarily to scale, presenting a somewhat simplified representation of various features illustrative of the basic principles of the present disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Specific structural or functional descriptions set forth in the embodiments of the present disclosure are merely exemplarily given to describe the embodiments depending on the concept of the present disclosure, and the embodiments depending on the concept of the present disclosure may be embodied in different forms. Further, the present disclosure should not be construed as being limited to the embodiments set forth herein, and it should be understood that the present disclosure includes all modifications, equivalents, or substitutes included in the spirit and technical scope of the disclosure.

In the following description of the embodiments, terms, such as “first” and “second,” and the like, are used only to describe various elements, and these elements should not be construed as being limited by these terms. These terms are used only to distinguish one element from other elements. For example, a first element described hereinafter may be termed a second element, and similarly, a second element described hereinafter may be termed a first element, without departing from the scope of the disclosure.

When an element or layer is referred to as being “connected to” or “coupled to” another element or layer, the component may be directly connected or coupled to the other element or layer, or intervening elements or layers may be present. In contrast, when an element or layer is referred to as being “directly connected to” or “directly coupled to” another element or layer, there may be no intervening elements or layers present. Other words used to describe relationships between elements should be interpreted in a like fashion, e.g., “between” versus “directly between,” “adjacent” versus “directly adjacent,” and the like.

Wherever possible, the same reference numbers are used throughout the following description to refer to the same or like parts. The terminology used herein is for the purpose of describing particular embodiments only and is not intended to be limiting. As used herein, singular forms may be intended to include plural forms as well, unless the context clearly indicates otherwise. The terms “comprises,” “comprising,” “including,” and “having” are inclusive and therefore specify the presence of stated features, integers, steps, operations, elements, components, and/or combinations thereof, but do not preclude the presence or addition of one or more other features, integers, steps, operations, elements, components, and/or combinations thereof.

When a component, unit, controller, device, element, apparatus, or the like of the present disclosure is described as having a purpose or performing an operation, function, or the like, the component, unit, controller, device, element, apparatus, or the like should be considered herein as being “configured to” meet that purpose or to perform that operation or function. Each component, unit, controller, device, element, apparatus, and the like may separately embody or be included with a processor and a memory, such as a non-transitory computer readable media, as part of the apparatus.

Hereinafter, the present disclosure is described in detail with reference to the accompanying drawings.

As previously discussed, solenoid valves are widely used to control the flow of fluid through flow paths. A fluid flow control apparatus according to the present disclosure is configured to control the flow of fluid using a solenoid valve. Although the fluid flow control apparatus is described herein as being based on operation of the solenoid valve among valves, the fluid flow control apparatus may be operated by other types of valves that may cause a heat generation problem, in addition to the solenoid valve.

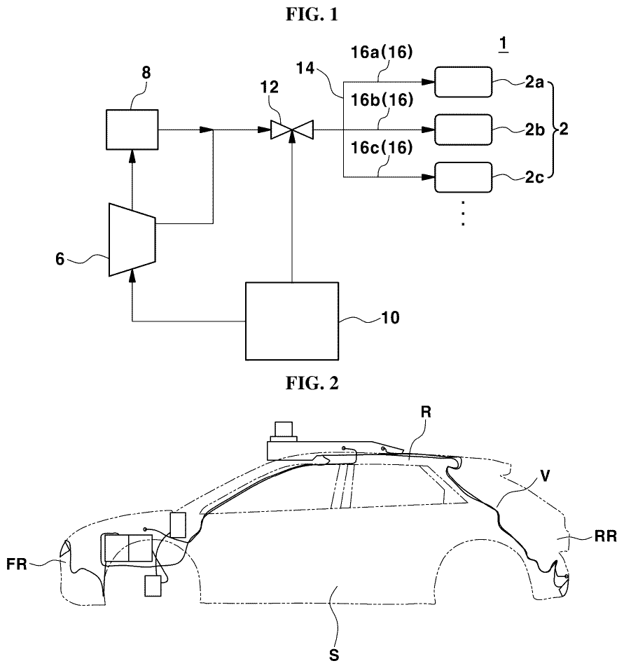

As shown in FIGS. 1 and 2, according to one embodiment, a fluid flow control apparatus 14, 100 may be applied to a sensor cleaning system 1 of a vehicle V. However, the sensor cleaning system 1 is only an example to which the fluid flow control apparatus 14 is applicable, and the fluid flow control apparatus 14 may be applied to other systems that require control of a flow of fluid.

For a driver assistance system or autonomous driving, the vehicle V may be provided with several environment, or environmental, sensors 2 that may detect a surrounding environment. As a non-limiting example, the environment sensors 2 may include a lidar sensor, a radar sensor, a camera, and the like. The environment sensors 2 may be disposed at various positions, such as a front region FR, a rear region RR, a side region S, and a roof R of the vehicle V. In the drawings and description, three environment sensors 2a, 2b, and 2c are disclosed as examples, but the number of environment sensors 2 is not limited thereto and may be changed.

Because the environment sensors 2 are usually disposed outside the vehicle V, the environment sensors 2 may easily become dirty due to foreign substances, such as dust, or precipitation. In order to maintain performance, the environment sensors 2 must be maintained at a certain level of cleanliness. Therefore, the vehicle V may be provided with the sensor cleaning system 1 configured to clean the environment sensors 2 when they are contaminated (i.e., dirty).

The sensor cleaning system 1 is configured to clean the environment sensors 2 by spraying a fluid. As a non-limiting example, the fluid may be air or washer fluid.

The fluid is configured to be transported by a fluid transfer device 6. For example, the fluid transfer device 6 may be a compressor or a pump. Specifically, compressed air generated by the fluid transfer device 6, such as a compressor, may be used as a cleaning fluid, or a washer fluid compressed by the fluid transfer device 6, such as a pump, may be used as the cleaning fluid.

A tank 8 is configured to store the fluid. If the fluid is a compressed fluid, the compressed fluid generated by the compressor as the fluid transfer device 6 may be stored in the tank 8. If a pump is used as the fluid transfer device 6, the fluid stored in the tank 8 may be transported by the pump.

A controller 10 is configured to control operation of the sensor cleaning system 1. In one embodiment, the controller 10 is configured to open controllable valves 12, such as solenoid valves, at a predetermined period, or periods. In one embodiment, the controller 10 is configured to open the valves 12 in a predetermined condition, such as when contamination of the environment sensors 2 is detected. This allows the fluid from the tank 8 to be directed to the environment sensors 2, thereby performing cleaning of the environment sensors 2. In one embodiment, the valves 12 may be provided in or formed integrally with the fluid flow control apparatus 14.

The fluid flow control apparatus 14 is configured to divide the flow of the fluid from the tank 8 into a plurality of flows. In one embodiment, the fluid flow control apparatus 14 may include a plurality of valves 12. In one embodiment, the fluid flow control apparatus 14 is configured to selectively distribute the fluid through nozzles 16a, 16b, and 16c (collectively, 16) provided for the respective environment sensors 2a, 2b, and 2c through selective operation of the respective valves 12.

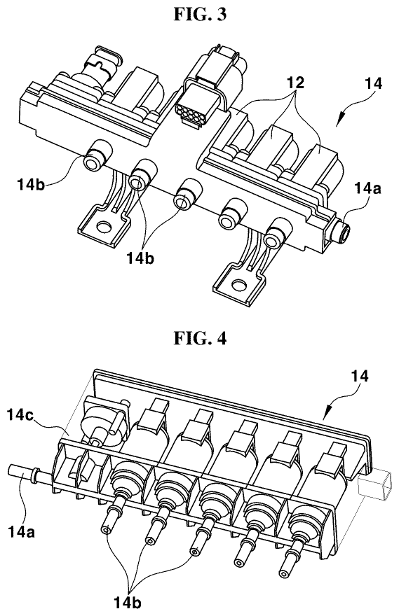

As shown in FIG. 3, the fluid flow control apparatus 14 according to one embodiment may include an inlet port 14a and one or more outlet ports 14b. The fluid may be supplied from the tank 8 through the inlet port 14a of the fluid flow control apparatus 14, and the fluid may be discharged through the outlet ports 14b. The valve(s) 12 may be operably coupled to each of the outlet ports 14b configured to be in fluid communication with the inlet port 14a. Each of the outlet ports 14b may be configured to be selectively opened and closed by operation of a corresponding one of the valves 12, and the fluid may be sprayed to a specific environment sensor 2 through the nozzle 16 configured to be in fluid communication with each of the outlet ports 14b. In one example, the opening and closing operations of the valves 12 may be controlled by the controller 10. The controller 10 is configured to supply power to a specific valve 12 to open the corresponding valve 12.

An operation for cleaning the environment sensors 2 may be directly connected to the number of times the corresponding valves 12 are operated in the fluid flow control apparatus 14. In bad weather, such as heavy rain, the number of operating times of the valves 12 must increase in order to ensure normal operation of the environment sensors 2. As shown in FIG. 4, the valves 12 are disposed in a casing 14c of the fluid flow control apparatus 14. In order to protect the valves 12 from external environments, such as rain and direct sunlight, the valves 12 are configured to be located in the casing 14c of the fluid flow control apparatus 14. However, such a structure is disadvantageous in discharging heat generated from the valves 12 to the outside. In addition, as described above, when the number of operating times of the valves 12 increases, heat generated by the valves 12 increases.

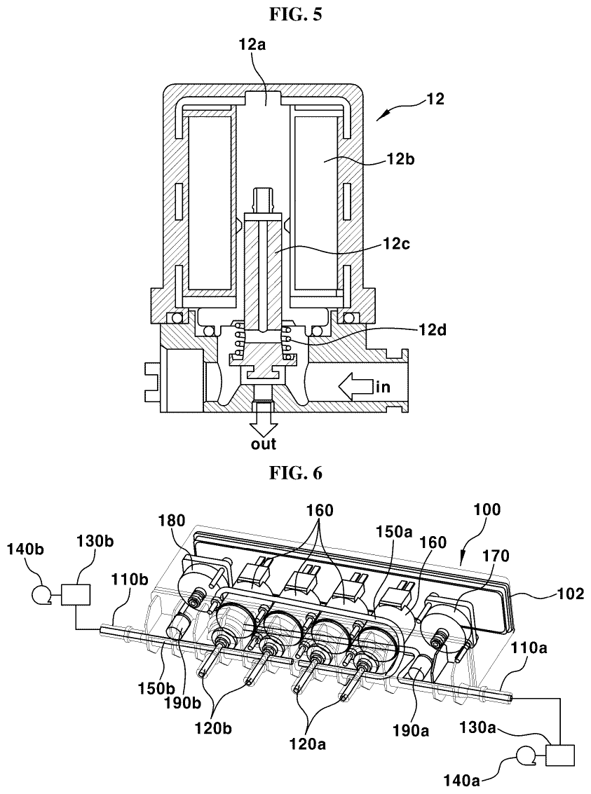

Referring to FIG. 5, the valve 12, such as a solenoid valve, includes a core 12a and a coil 12b. The coil 12b is wound on the core 12a. When power is supplied to the coil 12b, current may flow along the coil 12b. A magnetic field is formed at the core 12a by the current flowing through the coil 12b, so a plunger 12c may move upward from a closed position, as shown in FIG. 5, to an open position. As the plunger 12c moves upward, the corresponding outlet port 14b may be opened, and the fluid may be discharged through the corresponding outlet port 14b.

When supply of power is cut off, the plunger 12c returns to the original position of the plunger 12c, i.e., the closed position, by a spring 12d connected to the plunger 12c, and the outlet port 14b may be closed. Because the valve 12, such as a solenoid valve, generates heat due to the current flowing along the coil 12b, the operating temperature, operating cycle, and allowable current of the valve 12 may be limited to avoid problems that may occur due to heat.

In the case of the sensor cleaning system 1, if the fluid flow control apparatus 14 is operated in a situation in which frequent operation of the sensor cleaning system 1 is required in bad weather, it is difficult to avoid problems due to heat generated by the valve 12. If the number of times of sensor cleaning is reduced to avoid the heat problem, autonomous driving of the vehicle V may become difficult. Because the operating temperature of the valve 12 or the number of operating times of the valve 12 are determined by external conditions, allowable current must ultimately be reduced to resolve the heat generation problem. However, if the operating current of the valve 12 is reduced, the intensity of a magnetic field formed when power is supplied to the valve 12 is decreased. To avoid this, the size of the valve 12 must be increased, but in the case of a vehicle V where space is limited and cost and weight are important factors, increasing the size of the valve 12 may be difficult.

According to the present disclosure, a fluid flow control apparatus 100 having improved performance compared to the above-described fluid flow control apparatus 14 may be proposed to resolve the heat generation problem of solenoid valves. According to one embodiment of the present disclosure, the fluid flow control apparatus 100 is configured to cool solenoid valves using a washer fluid as a cooling fluid. The washer fluid has higher thermal conductivity and specific heat than air, thus having suitable characteristics as the cooling fluid. In addition, the fluid flow control apparatus 100 is obtained by integrating a fluid flow control apparatus for air and a fluid flow control apparatus for the washer fluid and may thus provide cooling to even the fluid flow control apparatus for air without adding a separate cooling component.

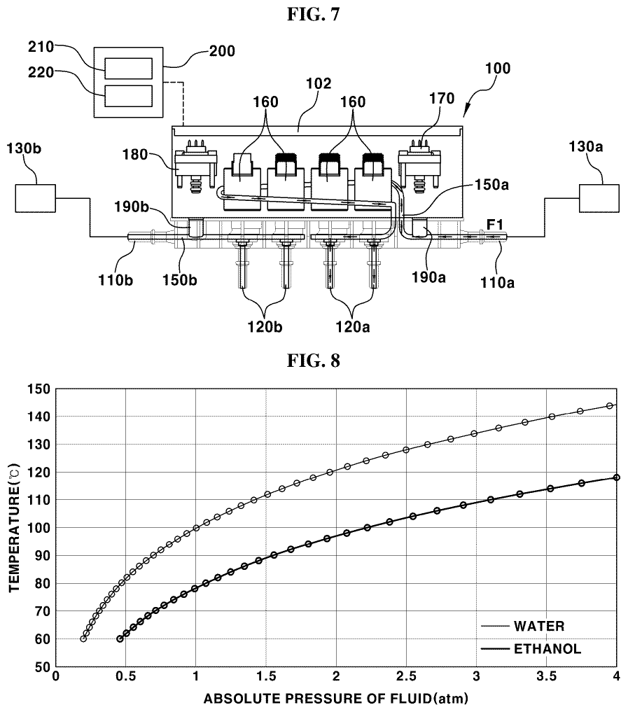

Referring to FIGS. 6 and 7, the fluid flow control apparatus 100 is configured to direct fluids supplied into a housing 102 of the fluid flow control apparatus 100 in a plurality of directions. In one embodiment, the fluid flow control apparatus 100 includes one or more inlets 110a and 110b and one or more outlets 120a and 120b. The fluid introduced through the one or more inlets 110a and 110b may be directed through the outlets 120a and 120b.

According to one embodiment, the fluid flow control apparatus 100 may include a first inlet 110a into which a first fluid flows and a second inlet 110b into which a second fluid flows. The first fluid and the second fluids may be the same fluid or different fluids. For example, the first fluid may be a washer fluid and the second fluid may be air. According to the present disclosure, the fluid flow control apparatus 100 is obtained by integrating the fluid flow control apparatus for air and the fluid flow control apparatus for the washer fluid and may thus provide cooling even to the fluid flow control apparatus for air.

In one embodiment, the first inlet 110a may be in fluid communication with a first tank 130a. The second inlet 110b may be in fluid communication with a second tank 130b. In one embodiment, if the first fluid and the second fluid are the same, the first inlet 110a and the second inlet 110b may be connected to one tank. In one embodiment, if the first fluid and the second fluid are different, the respective inlets 110a and 110b may be connected to the corresponding separate tanks 130a and 130b. In the illustrated embodiment, the first tank 130a is configured to store the washer fluid, and the second tank 130b is configured to store air. Fluid transfer devices 140a and 140b may be fluidly coupled to the respective tanks 130a and 130b. The fluid transfer devices 140a and 140b may include, for example, a pump or a compressor. For example, the first fluid transfer device 140a may be configured to be in fluid communication with the first inlet 110a, and the second fluid transfer device 140b may be configured to be in fluid communication with the second inlet 110b.

The respective inlets 110a and 110b may be configured to be in fluid communication with the outlets 120a and 120b. The inlets 110a and 110b may be connected to the outlets 120a and 120b by flow paths 150a and 150b. The first inlet 110a is configured to be in fluid communication with the first outlets 120a by the first flow path 150a. The second inlet 110b is configured to be in fluid communication with the second outlets 120b by the second flow path 150b. As shown in the illustrated embodiment, a plurality of first outlets 120a may be provided, and a plurality of second outlets 120b may be provided.

According to one embodiment of the present disclosure, the first flow path 150a and the second flow path 150b may be independent of each other. In other words, the first fluid passing through the first flow path 150a and the second fluid passing through the second flow path 150b are configured to flow independently of each other through the respective flow paths 150a and 150b.

In one embodiment, each of the flow paths 150a and 150b is configured to form a single flow passage so that a portion of the fluid that enters the fluid flow control apparatus 100 first may be sprayed first. Particularly, the first flow path 150a may extend from the first inlet 110a to the first outlets 120a through a single flow passage. As the first flow path 150a is formed as a single flow passage, when the fluid flow control apparatus 100, which is described below, discharges the overheated first fluid, a portion of the first fluid that enters the housing 102 first may be discharged from the housing 120 first.

The flow of the fluid from each inlet 110a or 110b to the corresponding outlets 120a and 120b may be controlled. In one embodiment, the fluid flow control apparatus 100 may include one or more valves 160. In one embodiment, the valves 160 may be provided in the same number as the outlets 120a and 120b.

The valves 160 may be controlled to allow or block the flow of the fluid through each outlet 120a and 120b. As a non-limiting example, the valves 160 may be solenoid valves and have a configuration similar to the valves 12 described above. By controlling the valves 160, the respective outlets 120a and 120b may be opened simultaneously, or the respective outlets 120a and 120b may be opened at different times. Some of the outlets 120a and 120b may be opened, and others of the outlets 120a and 120b may not be opened. In other words, the valves 160 may selectively allow and block the flow of the fluid though the outlets 120a and 120b. In one embodiment, one or more first outlets 120a may be opened simultaneously or at different times. In one embodiment, one or more second outlets 120b may be opened simultaneously or at different times.

The valves 160 may be surrounded (i.e., encircled, bordered, and the like) by, at least partially, the flow paths 150a and 150b. The periphery of the valves 160 may be surrounded by the flow paths 150a and 150b at least once. In one example, only one of the flow paths 150a and 150b surround the valves 160. In one embodiment, the valves 160 may be surrounded by the first flow path 150a configured to allow the washer fluid to flow therethrough. The first flow path 150a is configured to surround not only the valves 160 operably coupled to the first outlets 120a but also the valves 160 operably coupled to the second outlets 120b. According to one embodiment of the present disclosure, the washer fluid flowing through the first flow path 150a is configured to contact the valves 160 so as to cool the valves 160. The first fluid flowing in a flow direction F1 through the first flow path 150a is configured to exchange heat with the valves 160 surrounded by the first flow path 150a, thereby being capable of cooling the valves 160. The washer fluid has higher thermal conductivity and specific heat than air, thus having suitable characteristics as a cooling fluid.

The fluid flow control apparatus 100 may include at least one temperature-pressure sensor 170. In one embodiment, the temperature-pressure sensor 170 is configured to measure both the temperature and pressure of the fluid. In some embodiments, a temperature sensor and a pressure sensor may be provided separately.

The temperature-pressure sensor 170 is configured to measure the temperature and pressure of the first fluid flowing through the first flow path 150a in real time. In one embodiment, a first measurement zone 190a may be provided in the first flow path 150a. The temperature-pressure sensor 170 is disposed in association with the first measurement zone 190a and configured to measure the temperature and pressure of the first fluid passing through the first flow path 150a in real time.

The fluid flow control apparatus 100 may include at least one pressure sensor 180. The pressure sensor 180 is configured to measure the pressure of the second fluid. In one embodiment, a second measurement zone 190b may be provided in the second flow path 150b. The pressure sensor 180 is disposed in relation to the second measurement zone 190b and configured to measure the pressure of the second fluid passing through the second flow path 150b in real time.

The fluid flow control apparatus 100 may further include a controller 200. The controller 200 is configured to control operation of the fluid flow control apparatus 100. In one embodiment, the controller 200 is configured to control operation of the valves 160. In one embodiment, the controller 200 is configured to communicate with the temperature-pressure sensor 170 and the pressure sensor 180. The controller 200 is configured to receive measured values from the temperature-pressure sensor 170 and the pressure sensor 180 and perform a series of predetermined operations. For this purpose, the controller 200 may include a memory 210 and a processor 220. The memory 210 is configured to store commands, such as computer-executable instructions (e.g., executable software code), that are executable by the processor 220. The processor 220 is configured to read and execute the commands stored in the memory 210.

According to one embodiment of the present disclosure, the commands may include a command for preventing damage to the fluid flow control apparatus 100. If a fluid, such as a washer fluid, is used as a cleaning fluid and a cooling fluid, the fluid flow control apparatus 100 may be damaged due to the properties of the washer fluid. In order to prevent this, the damage to the fluid flow control apparatus 100 may be prevented through execution of the above command by the controller 200.

The washer fluid includes water, alcohol, and a surfactant as main components. Ethanol is generally used as the alcohol. The washer fluid in the fluid flow control apparatus 100 is not subject to pressure under normal conditions (for example, if the fluid flow control apparatus 100 is not operated to perform sensor cleaning), and thus has an absolute pressure of 1 atm. The boiling point of ethanol at 1 atm is approximately 78° C. If the washer fluid is overheated and vaporized due to heat exchange with the valves 160, the volume of the washer fluid increases, and thereby, the fluid flow control apparatus 100 may be damaged. Accordingly, according to the present disclosure, the fluid flow control apparatus 100 may be prevented from being damaged through execution of the command for preventing damage to the fluid flow control apparatus 100.

Particularly, the controller 200 is configured to execute a damage prevention operation based on the boiling point of ethanol and the current temperature of the washer fluid. As shown in FIG. 8, the boiling point of ethanol changes depending on the pressure. In a system that compresses and sprays fluid (e.g., the above-described sensor cleaning system 1), the fluid pressure in the fluid flow control apparatus 100 may be variable. Therefore, the controller 200 is configured to consider both the temperature and pressure of the washer fluid in the fluid flow control apparatus 100 in order to calculate the boiling point of ethanol in real time.

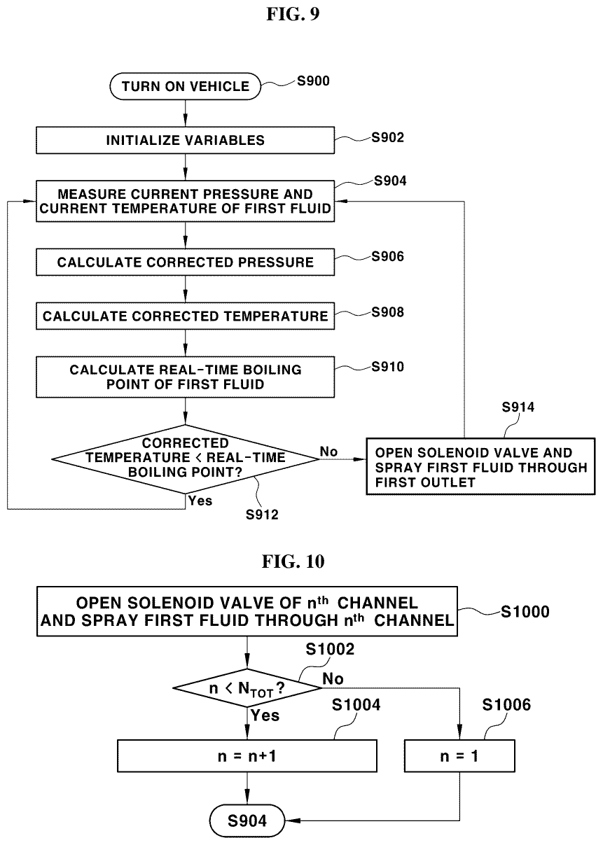

As shown in FIG. 9, when the command is executed by the processor 220, operations as shown in the flowchart illustrated in FIG. 9 are executed.

At Operation S900, the vehicle V is turned on. The controller 200 may receive on-status information of the vehicle V from a vehicle control unit.

In response to turning on the vehicle V, the controller 200 initiates or initializes variables related to the fluid flow control apparatus 100 (S902). The variables are set forth in Table 1 below. Units, initialization values, and the like, assigned in Table 1 are only examples and may be changed.

TABLE 1

| | | | Initialization |
|---|---|---|---|
| Category | Description | Unit | value |
| Pᵣ | Current pressure of first fluid | atm | 0 |
| | (washer fluid) | | |
| P_{abs} | Corrected pressure of first fluid | atm | 1 |
| Tᵣ | Current temperature of first fluid | ° C. | 20 |
| T_{c} | Corrected temperature of first | ° C. | 20 |
| | fluid | | |
| Bₑ | Real-time boiling point of first | ° C. | 78 |
| | fluid | | |
| n | No. of first outlet | — | 1 |

| | | |
|---|---|---|
| N_{TOT} | Total number of first outlets | Constant |

At Operation S904, the controller 200 may collect the current pressure Pᵣ and the current temperature Tᵣ of the first fluid. The current pressure Pᵣ and the current temperature Tᵣ of the first fluid may be measured by the temperature-pressure sensor 170, and the measured pressure Pᵣ and temperature Tᵣ may be transmitted to the controller 200.

At Operation S906, the controller 200 may calculate a corrected pressure P_{abs}, which is the absolute pressure of the first fluid, based on the received current pressure Pᵣ of the first fluid. Particularly, the controller 200 may calculate the corrected pressure P_{abs} by Equation 1 below. The corrected pressure P_{abs} becomes the current absolute pressure of the first fluid.

$${P}_{a b s} = {P}_{r} + 1 atm \qquad [ Equation 1 ]$$

At Operation S908, the controller 200 may calculate the corrected temperature T_{c} of the first fluid based on the received current temperature Tᵣ of the first fluid. The corrected temperature T_{c} may be a temperature value in which the safety margin Tₘ of the temperature of the first fluid for robustness of this logic is reflected. The corrected temperature T_{c} may be calculated by Equation 2 below.

$${T}_{c} = {T}_{r} + {T}_{m} \qquad [ Equation 2 ]$$

At Operation S910, the controller 200 may calculate the real-time boiling point Be of the first fluid. The real-time boiling point Be of the first fluid may be calculated using the vapor pressure calculation formula or vapor pressure curve of the first fluid. Because the washer fluid is a mixture of water and ethanol, when the temperature rises, ethanol with a high vapor pressure vaporizes at a higher specific gravity than water. Therefore, according to the present disclosure, discharge for damage prevention may be performed based on the real-time boiling point of ethanol. In one embodiment, the real-time boiling point Be of ethanol may be calculated based on a vapor pressure calculation formula (i.e., the Antoine Equation) or a vapor pressure curve (or a vapor pressure table). In one embodiment, the controller 200 may calculate the real-time boiling point Be through Equation 3 below, to solve for temperature.

$${B}_{e} = \frac{B}{A - log ( 760 \times {P}_{a b s} )} - C \qquad [ Equation 3 ]$$

In this example, constants may be used as parameters A, B, and C regardless of a temperature range (A=8.04494, B=1554.3, C=222.65). For high accuracy calculation, different parameter values may be used depending on the temperature range. However, it has been confirmed that the error range of the boiling point is within a maximum of 3° C. even if several parameter values are used. Therefore, in the present disclosure, considering simplification of the logic, increase in the specific heat of ethanol depending on temperature increase, a higher boiling point obtained if the parameter values are changed depending on the temperature, and the like, parameter values, each of which is fixed to one value, may be used.

At Operation S912, the controller 20 may determine whether the corrected temperature T_{c} is lower than the calculated real-time boiling point Bₑ. If the corrected temperature T_{c} is less than the calculated real-time boiling point Bₑ (Yes at S912), the controller 200 returns to Operation S904.

If the corrected temperature T_{c} is greater than or equal to the calculated real-time boiling point Bₑ (No at S912), the controller 200 may open the valves 160 at Operation S914. The controller 200 is configured to discharge the overheated first fluid so that the first fluid reaches a temperature lower than the real-time boiling point Bₑ. When the valves 160 are opened, the first fluid may be sprayed through the one or more first outlets 120a. For example, the overheated first fluid in the sensor cleaning system 1 may be sprayed to the environment sensors 2 through the nozzles 16.

Referring to FIG. 10, when discharging the overheated first fluid, the valves 160 may be controlled so that the first fluid is sequentially discharged from one of the one or more first outlets 120a to the last of the one or more first outlets 120a. According to the present disclosure, overall sensor cleaning may be sequentially performed to prevent waste of the first fluid when discharging the first fluid and serious contamination of the environment sensors 2.

At Operation S914, in response to the corrected temperature T_{c} that is greater than or equal to the calculated real-time boiling point Bₑ, the controller 200 may open the valve 160 of an n^{th} first outlet 120a to spray the first fluid through the n^{th} first outlet 120a at Operation S1000. In this example, n may be a natural number which means the number of the currently opened first outlet 120a.

After spraying the first fluid through the n^{th} first outlet 120a, the controller 200 may compare the number n of the currently opened first outlet 120a with the total number of N_{TOT} of the first outlets 120a at Operation S1002. If the number n of the currently opened first outlet 120a is less than the total number of N_{TOT} of the first outlets 120a (Yes at S1002), the controller 200 may update the number n with n+1 at Operation S1004 and return to Operation S904. If the number n of the currently opened first outlet 120a is not less than the total number of N_{TOT} of the first outlets 120a (No at S1002), it may be determined that spray of the first fluid has been performed from the one of the first outlets 120a to the last of the first outlets 120a, i.e., from first outlet #1 to first outlet #n. Accordingly, the controller 200 may initialize the number n of the first outlet 120a to 1 at Operation S1006 and return to Operation S904.

According to the present disclosure, there is provided a fluid flow control apparatus capable of cooling the valves through a fluid, such as the washer fluid, and simultaneously preventing damage to the apparatus due to overheating of the fluid.

As is apparent from the above description, the present disclosure provides a fluid flow control apparatus capable of resolving the heat generation problem of a solenoid valve.

The present disclosure provides a fluid flow control apparatus including a cooling function.

The present disclosure provides a fluid flow control apparatus being capable of increasing the number of times a valve is operated through a cooling function.

The present disclosure provides a fluid flow control apparatus including a cooling function without adding a complicated structure or part.

The present disclosure provides a fluid flow control apparatus capable of resolving a heat generation problem in a system requiring frequent operation of a solenoid valve.

The technical effects of the present disclosure are not limited to the above-described effects, and other technical effects not mentioned should be clearly recognized by those having ordinary skill in the art from the above description.

The present disclosure described above is not limited to the above-described embodiments and the accompanying drawings, and it should be apparent to those having ordinary skill in the art to which the present disclosure pertains that various substitutions, modification, and changes are possible within a scope that does not depart from the technical spirit of the present disclosure.

What is claimed is:

1. A fluid flow control apparatus comprising:
one or more first controllable valves configured to selectively discharge a flow of a first fluid through one or more first outlets; and
a first flow path allowing the flow of the first fluid to flow through the first flow path and disposed to surround the one or more first controllable valves.

2. The fluid flow control apparatus of claim 1, further comprising a first inlet configured such that the flow of the first fluid flows into the first inlet,
wherein the first flow path is configured to extend from the first inlet to the one or more first outlets and form a single flow passage from the first inlet to the one or more first outlets.

3. The fluid flow control apparatus of claim 1, further comprising:
one or more second controllable valves configured to selectively discharge a flow of a second fluid through one or more second outlets; and
a second flow path allowing the flow of the second fluid to flow through the second flow path and configured to be in fluid communication with the one or more second outlets.

4. The fluid flow control apparatus of claim 3, wherein the one or more first controllable valves, the first flow path, the one or more second controllable valves, and the second flow path are disposed in a housing.

5. The fluid flow control apparatus of claim 3, wherein the first flow path is configured to surround the one or more first controllable valves and the one or more second controllable valves.

6. The fluid flow control apparatus of claim 3, wherein the first fluid is a washer fluid, and the second fluid is compressed air.

7. The fluid flow control apparatus of claim 1, wherein the one or more first controllable valves and the one or more second controllable valves are solenoid valves.

8. The fluid flow control apparatus of claim 1, further comprising a temperature-pressure sensor configured to measure a pressure and a temperature of the flow of the first fluid flowing through the first flow path.

9. The fluid flow control apparatus of claim 8, wherein at least one first controllable valve of the one or more first controllable valves is opened or closed based on a temperature and pressure measured by the temperature-pressure sensor.

10. A method of controlling a fluid flow control apparatus, the method comprising:
measuring a current temperature and a current pressure of a fluid flowing through a flow path of the fluid flow control apparatus, the flow path comprising one or more outlets configured to discharge the fluid, wherein an openable valve is disposed at each of the one or more outlets, the flow path being disposed to surround the valves; and
determining whether to open a valve based on the current temperature and the current pressure of the fluid.

11. The method of claim 10, further comprising:
determining a corrected temperature aby applying a safety margin to the current temperature; and
determining whether to open the valve based on the corrected temperature and the current pressure of the fluid.

12. The method of claim 10, further comprising:
determining a corrected pressure by converting the current pressure into an absolute pressure; and
determining whether to open the valve based on the current temperature and the corrected pressure of the fluid.

13. The method of claim 12, further comprising:
determining a real-time boiling point of the fluid based on the corrected pressure;
comparing the current temperature with the real-time boiling point; and
opening the valve based on the current temperature being greater than or equal to the real-time boiling point.

14. The method of claim 13, further comprising:
determining a corrected temperature by applying a safety margin to the current temperature;
comparing the corrected temperature with the real-time boiling point; and
opening the valve based on the corrected temperature being greater than or equal to the real-time boiling point.

15. The method of claim 10, wherein the fluid comprises ethanol.

16. A sensor cleaning system comprising:
one or more first nozzles; and
a fluid flow control apparatus configured to direct a first fluid to each of the one or more first nozzles, the fluid flow control apparatus comprising:
a first flow path configured such that the first fluid flows through the first flow path;
one or more outlets connected to the first flow path and configured to be in fluid communication with each of the one or more first nozzles; and
one or more first valves configured to selectively discharge the first fluid through the one or more first outlets,
wherein the first flow path is configured to surround the one or more first valves.

17. The sensor cleaning system according to claim 16, further comprising:
one or more second nozzles,
wherein the fluid flow control apparatus further comprises one or more second valves configured to selectively discharge a second fluid through one or more second outlets, the second fluid configured to flow through the second flow path.

18. The sensor cleaning system according to claim 16, wherein the one or more first nozzles are configured to spray the first fluid on an environment sensor, wherein the one or more second nozzles are configured to spray the second fluid on the environment sensor, and wherein the one or more first valves and the one or more second valves are disposed in a housing.

19. The sensor cleaning system according to claim 18, wherein the first flow path is configured to surround both the one or more first valves and the one or more second valves.

20. The sensor cleaning system according to claim 18, wherein the environment sensor comprises a lidar sensor, a radar sensor, or a camera.
